(19) United States
(12) Patent Application Publication
(10) Pub. No.: US 2004/0149466 A1
(43) Pub. Date: Aug. 5, 2004

(54) Gear mechanism having protection against wrapping

(75) Inventor: Thomas Stark, Waiblingen (DE)

Correspondence Address: ROBERT W. BECKER & ASSOCIATES, Suite B, 707 Highway 66 East, Tijeras, NM, 87059, US

(73) Assignee: Andreas Stihl AG & Co. KG,, Waiblingen (DE)

(21) Appl. No.: 10/625,372

(22) Filed: Jul. 23, 2003

(30) Foreign Application Priority Data
Jul. 27, 2002 (DE) 102 34 361.6

(51) Int. Cl. A01B 5/00

(52) U.S. Cl. 172/518

(57) ABSTRACT

A gear mechanism, especially for an engine unit for cultivating ground, such as a power tiller gear mechanism, is provided and has a wrapping protection to prevent cut material from wrapping around. The wrapping protection is disposed radially outwardly of a portion of a shaft that is driven by the gear mechanism, and extends between two side components disposed on the shaft portion. The side components are in particular tiller stars. To avoid the cut material from wrapping around, the wrapping protection is rotatable about the shaft portion.

### BACKGROUND OF THE INVENTION

The present invention relates to a gear mechanism, especially for an engine unit for ground cultivation or tilling, such as, for example, a power trimmer gear mechanism, and is provided with protection against wrapping.

DE 196 12 092 discloses a wrapping protection for the cutter head of a brush cutter, with the protection being secured on the gearbox of the brush cutter and having a casing that projects to the cutting plane.

The protection against wrapping is intended to prevent cut or mowed material from penetrating into the space between the gearbox and a filament cassette that is mounted thereon.

In using power implements to cultivate ground, for example with a power tiller, cut or mowed material often wraps about the shaft of the gear mechanism. The removal of the wrapped-around cut material is complicated and presents a danger of injury to an operator.

It is therefore an object of the present invention to provide a gear mechanism, especially for an engine unit for cultivating ground, for example a power tiller gear mechanism, that is provided with a means to protect against the wrapping-around of cut material.

### BRIEF DESCRIPTION OF THE DRAWINGS

This object, and other objects and advantages of the present invention, will appear more clearly from the following specification in conjunction with the accompanying schematic drawings, in which:

FIG. 1 is an isometric view of one exemplary embodiment of an inventive power tiller gear mechanism;

FIG. 2 is a side view taken in the direction of the longitudinal axis of the shaft of the gear mechanism of FIG. 1;

FIG. 3 is a plan view of the power tiller gear mechanism of FIG. 1;

FIG. 4 is a cross-sectional view taken along the line IV-IV in FIG. 3; and

FIG. 5 is a schematic illustration of a modified embodiment of the inventive means for protecting against wrapping.

### SUMMARY OF THE INVENTION

The gear mechanism of the present invention comprises a means to protect against wrapping that is disposed radially outwardly of a portion of a shaft that is driven by the gear mechanism, wherein the means to protect against wrapping extends between two side components that are disposed on the shaft portion, and wherein the means to protect against wrapping is rotatable about such shaft portion.

Due to the fact that the means to protect against wrapping is rotatable about the shaft portion, it is possible to prevent cut material from wrapping around. The means to protect against wrapping can rotate or be stationary between the side components during operation. Due to the rotatable arrangement, the means to protect against wrapping can stop, as soon as a force is produced by wrapped-around cut material, while the output shaft of the gear mechanism continues to rotate. There is only a slight or even no relative movement between the cut material and the means to protect against wrapping.

It can be expedient for the means to protect against wrapping to be disposed between the side components with axial play, in other words, play that extends in the direction of the axis of rotation of the shaft portion. This results in an easy fabrication for the means to protect against wrapping, since during the manufacturing process large tolerances can be permitted. During operation of the gear mechanism, the means to protect against wrapping can, with slip or without slip, rotate with the output shaft or be stationary. The side components are advantageously fixedly disposed on the shaft portion. It can then be expedient for the means to protect against wrapping to be frictionally held between the two side components. Thus, when there is no load the means to protect against wrapping rotates with the output shaft in a slip-free manner. When load exists, due to the frictional engagement a relative movement of the output shaft relative to the means to protect against wrapping is possible. The means to protect against wrapping can be stationary relative to the cut material, or can carry out a relative movement relative to the cut material, whereby the difference in speed is considerably less than that between the output shaft and the cut material.

The means to protect against wrapping is advantageously centered relative to the shaft portion. The centering can expediently be formed by a shoulder or abutment that is fixedly connected with the shaft portion. However, it can also be advantageous for the centering to be formed by at least one collar that is fixedly connected with the means to protect against wrapping, with such collar cooperating with the side components or with the shaft portion.

Pursuant to one specific embodiment of the present invention, at least one of the side components is a tiller star. When using the means to protect against wrapping for a power tiller gear mechanism, the two side components are two adjacent tiller stars that are disposed on one side of a housing of the gear mechanism. However, it can also be expedient for one of the side components to be connected with the non-moved gearbox or gear mechanism housing. In particular, one of the side components is a flange. A simple, easy manufacturing ability results from the embodiment of the means to protect against wrapping as a cylindrical sleeve.

Further specific features of the present invention will be described in detail subsequently.

### DESCRIPTION OF PREFERRED EMBODIMENTS

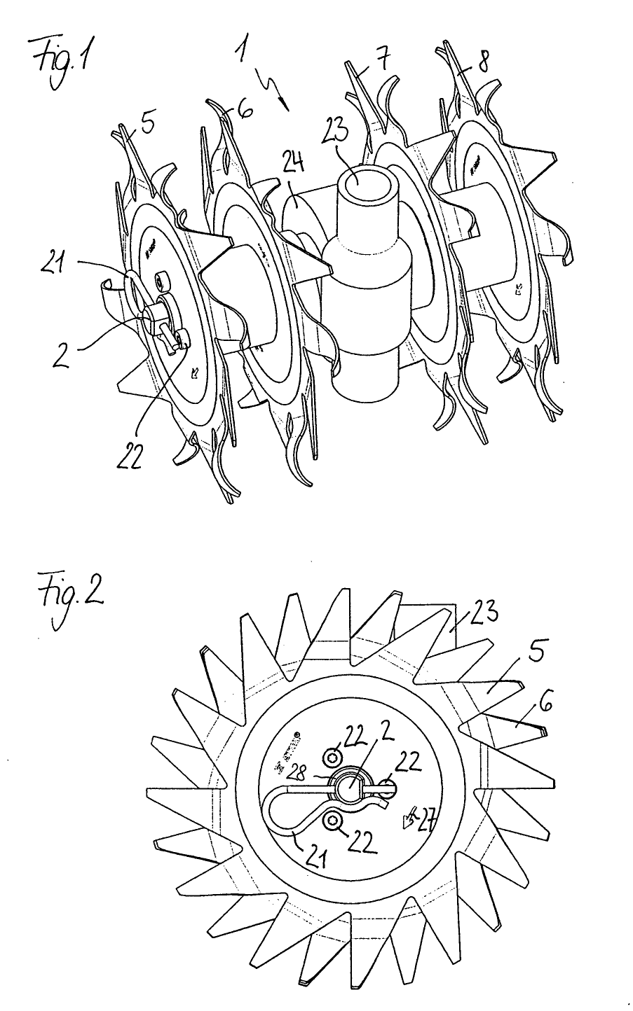

Referring now to the drawings in detail, the gear mechanism 1 for a power cultivator or tiller, and illustrated isometrically in FIG. 1, serves for driving the four tiller stars 5, 6, 7 and 8. The gear mechanism 1 has a receiving means 23 for a non-illustrated drive shaft. The gear mechanism 1 has a gearbox 24 in which, for example, gears or worm gears can be disposed that transmit the rotation of the drive shaft that is disposed in the receiving means 23 to an output shaft 2. This output shaft rotates in the direction of the arrow 27 illustrated in FIG. 2.

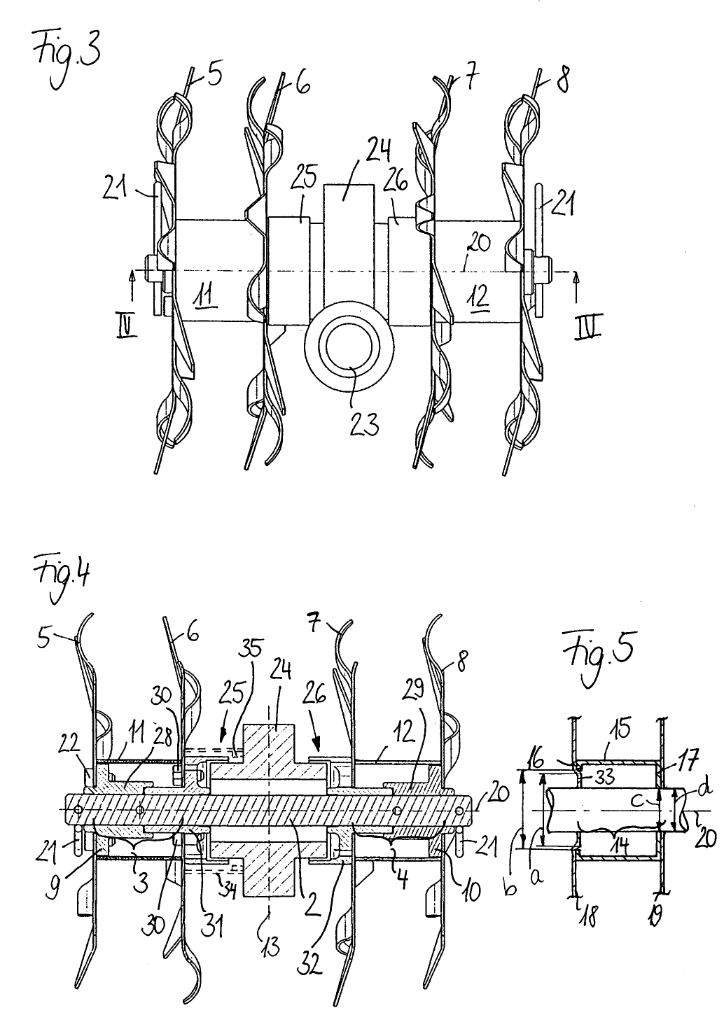

As can be recognized in particular in the plan view of FIG. 3, disposed between each two tiller stars 5 and 6 on the one hand, and 7 and 8 on the other hand, is a sleeve 11 or 12 respectively. The two side components 5, 6 and 7, 8 are thereby respectively disposed on one or the other side of the housing or gearbox 24 of the power tiller gear mechanism 1. Furthermore disposed on both sides of the housing 24 is a respective means 25, 26 to protect against wrapping, with such means being embodied in the form of a labyrinth member.

As can be seen in the cross-sectional view of FIG. 4, in conjunction with the side view of FIG. 2, the outer tiller stars 5 and 8 are each connected by three bolts 22 to a hub 28, 29 that in turn is fixedly connected with the output shaft 2. In the axial direction, the hubs 28, 29 are secured toward the outside by a respective cotter pin 21, which can be best seen in FIGS. 1 and 2. The inner tiller stars 6 and 7 are fixed in position on the hubs 31 and 32 by bolts 30; these hubs at the same time form the means 25, 26 to protect against wrapping. The hubs 28 and 29, as well as the hubs 31 and 32, are respectively embodied symmetrically relative to a plane of symmetry 13. The means 25, 26 to protect against wrapping are embodied as labyrinth members that are respectively formed between a hub 31 or 32 and the housing 24. This prevents cut or mowed material from wrapping around in the region between the housing 24 and the tiller stars 6 or 7.

The sleeves 11 and 12 extend radially outwardly of the shaft portions 3 and 4 of the output shaft 2 between the two tiller stars 5 and 6 or 7 and 8 respectively. The tiller stars 5, 6, 7 and 8 form the side components that fix the sleeves 11 and 12 in the direction of the longitudinal axis 20 of the shaft. These sleeves 11 and 12 can have an axial play relative to the tiller stars 5 and 6 or 7 and 8. However, it can also be expedient for the sleeves 11 and 12 to be frictionally held between the two tiller stars 5 and 6 or 7 and 8 respectively. The sleeve 11 is centered relative to the output shaft 2 by the abutment 9, which is monolithically formed with the hub 28. Similarly, the sleeve 12 is centered relative to the output shaft 2 by the abutment 10, which is monolithically formed with the hub 29. However, a centering of the sleeves 11, 12 is not absolutely necessary.

During operation, the output shaft 2, with the hubs 28, 29, 31, and 32 that are fixedly disposed thereon, as well as with the tiller stars 5, 6, 7 and 8 that are fixedly disposed thereon, is rotated in the direction of the arrow 27 indicated in FIG. 2. The sleeves 11, 12 rotate via a frictional connection with the output shaft 2. If there is an axial play between the sleeves and the laterally disposed tiller stars, a sleeve 11, 12 can also be stationary or can rotate with slip. A sleeve 11, 12 can also be frictionally held on an abutment 9, 10. If cut material is wrapped about a sleeve 11, 12, there results between the sleeve 11, 12 and the cut material friction due to the relative movement, with the friction leading to a stoppage of the sleeves. A relative movement between the sleeves 11, 12 and the output shaft 2, with the components fixedly disposed thereon, takes place. However, since no or only very little relative movement takes place between the cut material and the sleeve 11 or 12, a wrapping-around of the cut material is prevented.

In FIG. 4, illustrated by dashed lines is a sleeve 34 that is held frictionally or with play on a shoulder 35 on the gearbox or housing 24. The sleeve 34 extends between the stationary gearbox 24 and the co-rotating tiller star 6, and can rotate with the output shaft 2 or can be fixed to the housing 24. As soon as cut material is wrapped about the sleeve 34, it stops, thereby preventing the cut material from wrapping around. Also on the opposite side it can be expedient to dispose a sleeve in addition or alternatively to the means 26 for protecting against wrapping.

A modified embodiment of a sleeve 15 is schematically illustrated in FIG. 5. The sleeve 15 has a collar 16 as well as a collar 17. The collars 16 and 17 extend perpendicularly to the longitudinal axis 20 of the shaft. In the region of the shaft portion 14, the sleeve 15 extends between two side components that are formed by tiller stars 18 and 19. The tiller star 18 has a circular recess 33, the outer diameter a of which corresponds approximately to the inner diameter b of the sleeve 15 at the collar 16. The oppositely disposed collar 17, as viewed in the axial direction, has an inner diameter c that corresponds approximately to the outer diameter d of the output shaft 2 in the region of the shaft portion 14. The sleeve 15 is thus centered relative to the output shaft 2 by the collars 16 and 17. At the centering, play can be provided; however, it is also possible to frictionally hold the sleeve 15 in the region of the centering. However, the sleeve 15 can also be frictionally held in the axial direction between the tiller stars 18 and 19. Here also, it can be expedient to provide axial play.

The gear mechanism with the means to protect against wrapping can expediently be utilized with power tillers, reversing brushes, reversing rollers, edgers, lawn aerators, scarifiers and similar implements. Other applications can also be advantageous.

The specification incorporates by reference the disclosure of German priority document 102 34 361.6 filed 27 Jul. 2002.

The present invention is, of course, in no way restricted to the specific disclosure of the specification and drawings, but also encompasses any modifications within the scope of the appended claims.

1. A gear mechanism comprising a means to protect against wrapping that is disposed radially outwardly of a portion of a shaft that is driven by said gear mechanism, wherein said means to protect against wrapping extends between two side components that are disposed on said shaft portion and wherein said means to protect against wrapping is rotatable about such shaft portion.

2. A gear mechanism according to claim 1, wherein said means to protect against wrapping is disposed between said two side components with axial play.

3. A gear mechanism according to claim 1, wherein said two side components are fixedly disposed on said shaft portion.

4. A gear mechanism according to claim 3, wherein said means to protect against wrapping is held in a frictional manner between said two side components.

5. A gear mechanism according to claim 1, wherein said means to protect against wrapping is disposed in a centered manner relative to said shaft portion.

6. A gear mechanism according to claim 5, wherein centering is effected by an abutment that is fixedly connected with said shaft portion.

7. A gear mechanism according to claim 5, wherein the centering is effected by at least one collar that is fixedly connected with said means to protect against wrapping.

8. A gear mechanism according to claim 1, wherein at least one of said side components is a tiller star.

9. A gear mechanism according to claim 8, wherein both of said side components are two adjacent tiller stars that are disposed on one side of a housing of said gear mechanism.

10. A gear mechanism according to claim 1, wherein one of said side components is connected with a housing of said gear mechanism, and wherein said housing is not moved.

11. A gear mechanism according to claim 1, wherein said means to protect against wrapping is a cylindrical sleeve.
